(19) United States
(12) Patent Application Publication
(10) Pub. No.: US 2014/0164040 A1
(43) Pub. Date: Jun. 12, 2014

(54) SCALABLE TRAINING

(71) Applicant: Sears Brands, LLC, Hoffman Estates, IL (US)

(72) Inventors: Bharath Sridharan, Glendale Heights, IL (US); Jen-Hao Yang, Schaumburg, IL (US); Sahil Bhagat, Hoffman Estates, IL (US)

(73) Assignee: Sears Brands, LLC, Hoffman Estates, IL (US)

(21) Appl. No.: 14/062,040

(22) Filed: Oct. 24, 2013

Related U.S. Application Data
(60) Provisional application No. 61/734,663, filed on Dec. 7, 2012.

(51) Int. Cl. G06Q 10/06

(52) U.S. Cl. CPC G06Q 10/063114
USPC 705/7.15

(57) ABSTRACT

Methods and apparatus are disclosed that utilizes voice mail messages to direct personalized employee training. Voice mail messages instruct an employee to perform various tasks. Employee actions are monitored to determine whether the various tasks were performed as instructed.

### BACKGROUND AND FIELD OF THE INVENTION

Various embodiments relate to employee training, and more, particularly to systems and methods for training employees to perform job related tasks.

Well-trained employees are likely to be highly-productive, successful employees. Moreover, people generally enjoy and take pride in activities they perform well. Thus, besides increasing productivity, employee training may also have a positive impact upon employee retention since training is likely to increase an employee's performance and thus enjoyment in performing the job at hand.

Unfortunately, when the economy slows or when profits decline, many organizations seek cuts in their training budgets. Quite often such cuts result in less training and thus may negatively impact productivity, retention, and general employee morale. Given the importance of a properly trained work force, training processes that are able to deliver training in a cost effective manner may aid all businesses and in particular business looking to cut training budgets due to economic conditions.

Limitations and disadvantages of conventional and traditional approaches should become apparent to one of skill in the art, through comparison of such systems with aspects of the present invention as set forth in the remainder of the present application.

### BRIEF SUMMARY OF THE INVENTION

Apparatus and methods of providing employees with individualized training are substantially shown in and/or described in connection with at least one of the figures, and are set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 shows a training system in accordance with an embodiment of the present invention.

FIG. 2 shows a highly-simplified embodiment of a computing device for use in the training system of FIG. 1.

FIG. 3 shows an employee database and training messages maintained by the training system of FIG. 1.

FIG. 4 shows a method implemented by the training system of FIG. 1.

### DETAILED DESCRIPTION OF THE INVENTION

Aspects of the present invention are related to employee training. More specifically, certain embodiments of the present inventions relate to systems and methods for training employees to perform job related tasks.

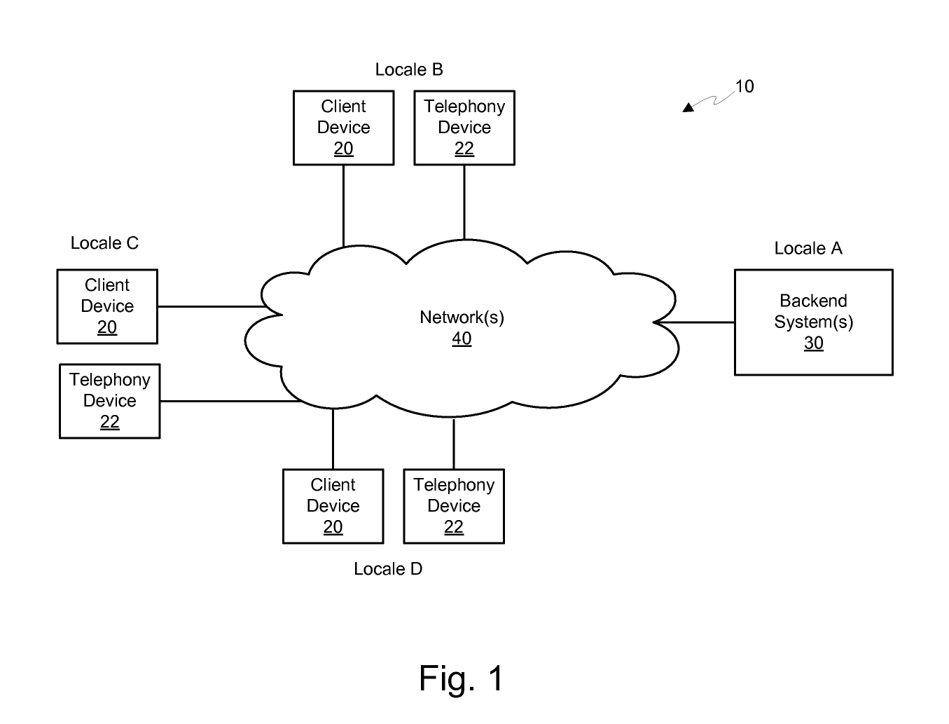

Referring now to FIG. 1, a highly-simplified depiction of training system 10 is provided. As shown, the training system 10 may include client devices 20 and telephony devices 22 connected to one or more backend systems 30 via one or more networks 40. The networks 40 may include a number of private and/or public networks such as, for example, wireless and/or wired local area network (LAN) networks, cellular networks, public switched telephone network (PSTN) networks, private branch exchange (PBX) networks, and global Internet Protocol networks (e.g., the Internet) that collectively provide a communication path and/or paths between the client devices 20 and the backend systems 30 and between telephony devices 22 and backend systems 30.

Each client device 20 may include a desktop, a workstation, a point of sale (POS) terminal, a mobile computing device (e.g., a laptop, personal digital assistance (PDA), a tablet, a smart phone, etc.) and/or some other type of computing device which enables an employee to communicate with one or more backend systems 30 via the network 40. The backend systems 30 may include one or more web servers, Voice over Internet Protocol (VoIP) servers, private branch exchange (PBX) servers, database servers, routers, load balancers, and/or other computing and/or networking devices that operate to provide various training services to employees.

Each telephony device 22 may permit an employee to place a telephone call and/or receive a telephone call in order to remotely conduct a conversation with another party. To this end, each telephony device 22 may include a plain old telephone service (POTS) telephone set, an Internet Protocol (IP) telephone set, a cellular phone, and/or a computing device with telephony capabilities. While FIG. 1 depicts telephony devices 22 separately from client devices 20, the client devices 20 in some embodiments may provide telephony capabilities. In such embodiments, the client devices 20 may eliminate separate telephony devices 22 and may instead provide the functionality of both the telephony device 22 and the client device 20.

FIG. 1 further depicts client devices 20, telephony devices 22, and backend systems 30 positioned at various locales. As noted above, the depicted training system 10 is presented in a highly simplified manner. As such, while FIG. 1 depicts a single client device 20 and telephony device 22 at locales B, C, and D, each locale in some embodiments may have multiple client devices 20 and telephony devices 22 and there may not be a one-to-one correspondence between client devices 20 and telephone devices 22 at a particular locale. Further, while FIG. 1 depicts backend systems 30 at locale A, the backend systems 30 in some embodiments may be distributed across multiple locales and such locales may also include one or more client devices 20 and/or telephony devices 22. Moreover, the locales A, B, C, D of FIG. 1 are merely illustrative and may take on different distinctions in different embodiments. For example, the locales may represent retail store locations, departments within a single retail store location, and/or geographical units such as counties, cities, states, countries, etc.

As noted above, the depicted training system 10 is highly simplified. Those skilled in the art readily appreciate that the training system 10 of FIG. 1 may be implemented in numerous different manners using a wide range of different computing devices, platforms, networks, etc. Moreover, those skilled in the art readily appreciate that while aspects of the training system 10 may be implemented using a client/server architecture, aspects of the training system 10 may, also or alternatively, be implemented using a peer-to-peer architecture or another networking architecture.

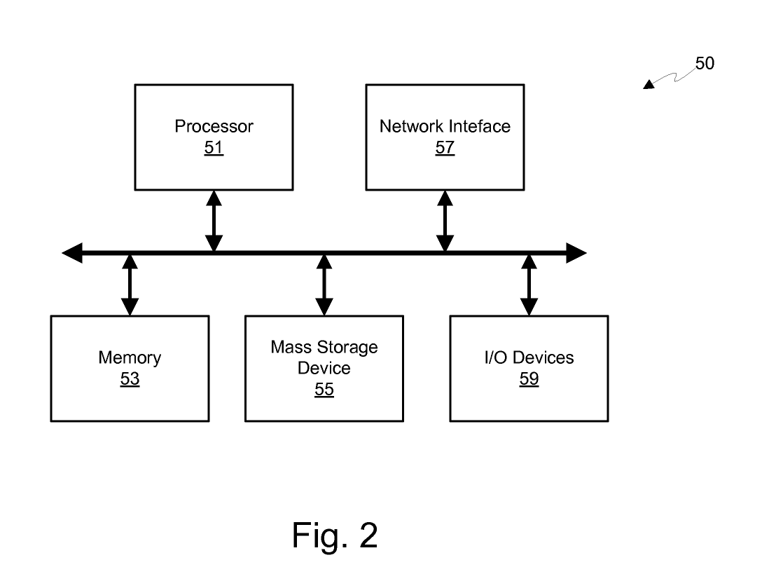

As noted above, the client devices 20 and the backend systems 30 may include various computing devices. FIG. 2 provides a highly-simplified depiction of a computing device 50 suitable for implementing a computing device of the client devices 20 and/or backend systems 30. As shown, the computing device 50 may include a processor 51, a memory 53, a mass storage device 55, a network interface 57, and various input/output (I/O) devices 59. The processor 51 may be configured to execute instructions, manipulate data and generally control operation of other components of the computing device 50 as a result of its execution. To this end, the processor 51 may include a general purpose processor such as an x86 processor or an ARM processor which are available from various vendors. However, the processor 51 may also be implemented using an application specific processor and/or other logic circuitry.

The memory 53 may store instructions and/or data to be executed and/or otherwise accessed by the processor 51. In some embodiments, the memory 53 may be completely and/or partially integrated with the processor 51.

In general, the mass storage device 55 may store software and/or firmware instructions which may be loaded in memory 53 and executed by processor 51. The mass storage device 55 may further store various types of data which the processor 51 may access, modify, and/otherwise manipulate in response to executing instructions from memory 53. To this end, the mass storage device 55 may comprise one or more redundant array of independent disks (RAID) devices, traditional hard disk drives (HDD), sold-state device (SSD) drives, flash memory devices, read only memory (ROM) devices, etc.

The network interface 57 may enable the computing device 50 to communicate with other computing devices via network 40. To this end, the networking interface 57 may include a wired networking interface such as an Ethernet (IEEE 802.3) interface, a wireless networking interface such as a WiFi (IEEE 802.11) interface, a radio or mobile interface such as a cellular interface (GSM, CDMA, LTE, etc), and/or some other type of networking interface capable of providing a communications link between the computing device 50 and network 40 and/or another computing device.

Finally, the I/O devices 59 may generally provide devices which enable a user to interact with the computing device 50 by either receiving information from the computing device 50 and/or providing information to the computing device 50. For example, the I/O devices 59 may include display screens, keyboards, mice, touch screens, microphones, audio speakers, etc.

While the above provides some general aspects of a computing device 50, those skilled in the art readily appreciate that there may be significant variation in actual implementations of a computing device. For example, a smart phone or tablet implementation of a computing device generally uses vastly different components and may have a vastly different architecture than a database server implementation of a computing device. However, despite such differences, computing devices still generally include processors that execute software and/or firmware instructions in order to implement various functionality. As such, the above described aspects of the computing device 50 are not presented from a limiting standpoint but from a generally illustrative standpoint. The present application envisions that aspects of the present application will find utility across a vast array of different computing devices and the intention is not to limit the scope of the present application to a specific computing device and/or computing platform beyond any such limits that may be found in the appended claims.

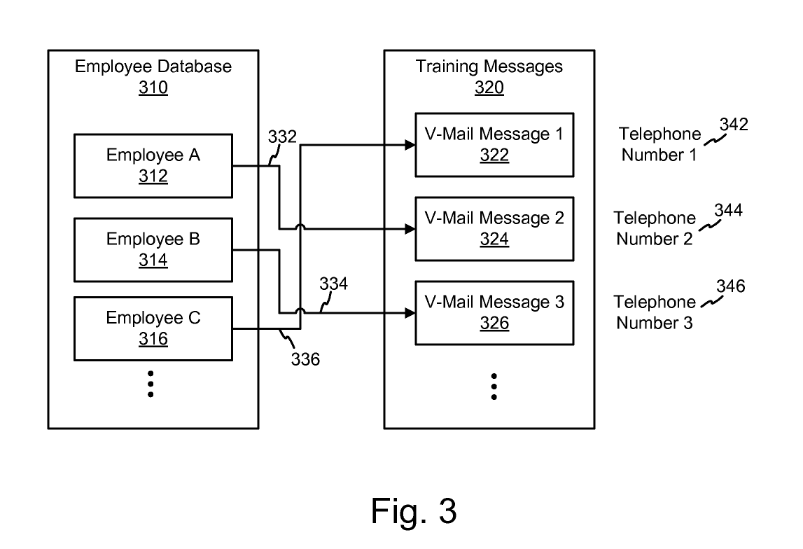

As noted above, the training system 10 may provide training services to employees. To this end, the training system 10 as shown in FIG. 3 maintains an employee database 310 and training messages 320. As shown, the employee database 310 may include employee records 312, 314, 316 that include various information about a respective employee. In particular, each employee record 312, 314, 316 may maintain a record of which training exercises have been attempted and/or successfully completed by the respective employee. Moreover, each employee record 312, 314, 316 may include a reference 332, 334, 336 or some other indicator that identifies a training exercise to be completed by the respective employee and a message of the training messages 320 associated with such training exercise.

As shown, the training messages 320 may include several distinct voice mail messages 322, 324, 326. Each voice mail message 322, 324, 326 further has an associated telephone number 342, 344, 346. In one embodiment, each voice mail message 322, 324, 326 has a distinct telephone number 342, 344, 346. Due to each having a distinct telephone number, the backend systems 30 may receive a telephone call directed to a particular telephone number and based on the telephone number of the received call may playback the associated voice mail message 322, 324, 326 to the caller.

In one embodiment, each voice mail message 322, 324, 326 corresponds to a different training exercise. In particular, by playing back the voice mail message, the backend system 30 may audibly instruct the caller/employee to perform one or more tasks associated with the training exercise. Moreover, in cases where an employee's duties include telephonic interactions with customers, the voice mail message may simulate such customer interaction and may present tasks in a manner similar to a manner a customer may request the employee to provide some level of service. Thus, a training exercise may not only test an employee's ability to perform a certain task, the training exercise may further provide the employee with a simulated experience of addressing and handling customer requests.

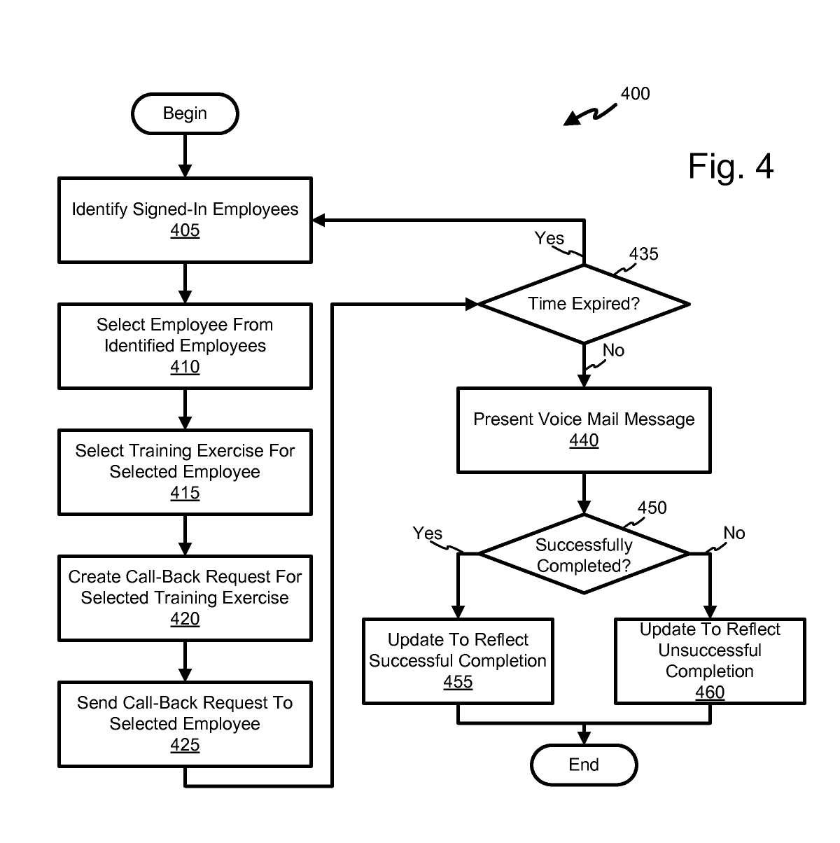

Further aspects of the training system 10 are addressed in reference to FIG. 4 which depicts a flowchart of a training process that may be implemented by the training system 10. As shown, a backend system 30 at block 405 may identify employees that are currently signed into one or more of the backend systems 30. In one embodiment, employees may sign into one or more backend systems 30 as part of their typical course of business. For example, employees may have computing device, such as a tablet computing device, that is assigned to or otherwise associated with the employee when the employee is on duty. The employee may sign into such computing device in order to gain access to various services provided by the backend systems 30. Moreover, the backend systems 30 at block 405 may utilize such sign-in information to identify which employee's are on duty and thus potentially available for a training exercise.

As block 410, a backend system 30 may select an employee from the employees identified at block 405. The backend system 30 may utilize various criteria for selecting such employee. For example, the backend system 30 may take into account which training exercises have been completed and/or which training exercises are still to be completed by a particular employee. The backend system 30 may further take into account the locale of the employee. For example, the backend system 30 may ensure that not more than a predetermined number (e.g., 1) of employees associated with a particular locale (e.g., store, department, etc) are undergoing training at the same time. In this manner, the backend system 30 may ensure that a particular locale is not overly taxed by the training exercises and that such locale retains an adequate workforce to handle work related tasks. The backend system 30 may further select based on other criteria such as whether the backend systems 30 indicate that the employee is currently busy handling other work related tasks, work related cycles (e.g., avoiding training during typical busy periods), employee's work schedule, employee's break schedule, etc.

At block 415, the backend systems 30 may select a training exercise for the selected employee. In particular, the backend systems 30 may select, based on the employee record of the employee database 310, a training exercise for the selected employee complete. Such selection may be based upon which training exercises the employee has completed. For example, in one embodiment, the backend systems 30 may store training messages 320 for a list of progressive training levels (e.g., level 1, level 2, level 3, etc.) in which an employee completes one training level before moving onto the next training level. In such an embodiment, the employee record of the database 310 may indicate which training levels have been completed, which training level is the next to be completed, and/or a reference to the next training level for the employee to complete.

After selecting an appropriate training exercise for the employee, the backend systems 30 may create a call-back request at block 420 and send the call-back request to the employee at block 425. In particular, the backend systems 30 may identify a voice mail message 322, 324, 326 for the respective training exercises and may identify the telephone number 342, 344, 346 for the respective voice mail message 322, 324, 326. The backend systems 30 may then send a message to the employee that requests the employee to call the telephone number 342, 344, 346 associated with the voice mail message 322, 324, 326 for the selected training exercise. The backend systems 30 may send such a call-back request to the employee using various communication mechanisms. For example, the backend systems 30 may send the employee an email message, an instant message (IM) message, a voice mail message, a short message service (SMS) text message which the employee may receive via a client device 20 and/or telephony device 22 associated with the employee.

At block 435, the backend systems 30 may wait a predetermined period of time (e.g. 10 minutes) for the employee to return the call-back message and/or completed the training exercise. After expiration of the predetermined period of time, the backend system 30 may cancel the current training exercise and return to step 405 to select another employee for training.

However, assuming the employee returns the call-back request, the backend systems 30 receive a call from the employee directed to a telephone number provided in the call-back request. Accordingly, the backend systems 30 present or otherwise playback at 440 the voice mail message associated with the telephone number of the call-back request. The presented voice mail message may request the employee to perform various tasks using a client device 20. The backend systems 30 may receive various signals as a result of the employee performing one or more tasks using the client device 20. The backend systems 30 may further provide the employee with additional information and/or additional requests via the client device 20. Regardless, the backend systems 30 may monitor activities of the employee at block 445. Based upon monitored activities and signals associated with such activities, the backend systems 30 may determine at block 450 whether the employee has successfully completed the tasks associated with the training exercise. At blocks 455 and 460, the backend systems 30 may update the employee record in the database 310 to reflect the outcome of the training exercise. In particular, the backend systems 30 at block 455 may update the employee record to reflect the successful completion of the training exercise. Conversely, the backend systems 30 at block 460 may update the employee record to reflect that the training exercise was not successfully completed in which case the backend systems 30 may request the employee to perform the same training exercise again at a later date.

Various embodiments of the invention have been described herein by way of example and not by way of limitation in the accompanying figures. For clarity of illustration, exemplary elements illustrated in the figures may not necessarily be drawn to scale. In this regard, for example, the dimensions of some of the elements may be exaggerated relative to other elements to provide clarity. Furthermore, where considered appropriate, reference labels have been repeated among the figures to indicate corresponding or analogous elements.

Moreover, certain embodiments may be implemented as a plurality of instructions on a tangible, computer readable storage medium such as, for example, flash memory devices, hard disk devices, compact disc media, DVD media, EEPROMs, etc. Such instructions, when executed by one or more computing devices, may result in the one or more computing devices providing one or more tasks associated with training employees in a manner as described above.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment or embodiments disclosed, but that the present invention encompasses all embodiments falling within the scope of the appended claims.

What is claimed is:

1. A method, comprising:
selecting an employee for a training exercise;
sending, to the selected employee, a call-back request that comprises a telephone number for a voice mail message associated with the training exercise;
presenting the voice mail message to the employee in response to an incoming telephone call directed to the telephone number of the call-back request; and
monitoring the employee to determine whether the employee has successfully completed the training exercise in response to the presented voice mail message.

2. The method of claim 1, further comprising:
identifying a plurality of employees who are currently signed into a computing system;
wherein said selecting comprises selecting the employee from the plurality of employees who are currently signed into the computing system.

3. The method of claim 1, further comprising:
identifying a plurality of employees who are currently signed into a computing system; and
identifying a location for each employee of the plurality of employees;
wherein said selecting comprises selecting the employee from the plurality of employees who are currently signed into the computing system such that greater than a threshold number of employees from the same location are not undergoing training at the same time.

4. The method of claim 1, further comprising:
storing a plurality of voice mail messages for a plurality of distinct training exercises, wherein each voice mail message of the plurality of voice mail messages is associated with a distinct telephone phone; and
selecting the training exercise and associated telephone number for the call-back request based on which training exercises of the plurality of training exercises the selected employee has successfully completed.

5. The method of claim 1, wherein:
said presenting the voice mail message to the employee simulates a customer's request for service; and
said monitoring comprises monitoring activities associated with the simulated customer's request for service.

6. The method of claim 1, wherein:
said presenting the voice mail message comprises instructing the employee to perform a task via a computer device associated with the employee; and
said monitoring comprises receiving signals from the computing device to determine, based upon the received signals, whether the task has been performed as requested.

7. The method of claim 1, further comprising updating data associated with the employee to indicate the employee has successfully completed the training exercise.

8. A computer readable medium, comprising a plurality of instructions that in response to being executed, result in one or more computer systems:
selecting an employee for a training exercise;
sending, to the selected employee, a call-back request that comprises a telephone number for a voice mail message associated with the training exercise;
presenting the voice mail message to the employee in response to an incoming telephone call directed to the telephone number of the call-back request; and
monitoring the employee to determine whether the employee has successfully completed the training exercise in response to the presented voice mail message.

9. The computer readable medium of claim 8, wherein the plurality of instructions further results in the one or more computer systems:
identifying a plurality of employees who are currently signed into a computing system;
wherein said selecting comprises selecting the employee from the plurality of employees who are currently signed into the computing system.

10. The computer readable medium of claim 8, wherein the plurality of instructions further results in the one or more computer systems:
identifying a plurality of employees who are currently signed into a computing system; and
identifying a location for each employee of the plurality of employees;
wherein said selecting comprises selecting the employee from the plurality of employees who are currently signed into the computing system such that greater than a threshold number of employees from the same location are not undergoing training at the same time.

11. The computer readable medium of claim 8, wherein the plurality of instructions further results in the one or more computer systems:
storing a plurality of voice mail messages for a plurality of distinct training exercises, wherein each voice mail message of the plurality of voice mail messages is associated with a distinct telephone phone; and
selecting the training exercise and associated telephone number for the call-back request based on which of the plurality of training exercises the selected employee has successfully completed.

12. The computer readable medium of claim 8, wherein the plurality of instructions further results in the one or more computer systems:
simulating a customer's request for service in response via the presented voice mail message to the employee; and
monitoring activities associated with the simulated customer's request for service to determine whether the employee has successfully completed the training exercise in response to the simulated customer's request for service.

13. The computer readable medium of claim 8, wherein the plurality of instructions further results in the one or more computer systems:
instructing the employee to perform a task via a computer device associated with the employee via the presented voice mail message to the employee; and
monitoring signals received from the computing device to determine, based upon the received signals, whether the task has been performed as requested.

14. The computer readable medium of claim 8, wherein the plurality of instructions further results in the one or more computer systems updating data associated with the employee to indicate the employee has successfully completed the training exercise.

15. A training system, comprising one or more backend systems, and a mobile computing device wirelessly coupled to the one or more backend systems via one or more networks, wherein:
the mobile computing device is configured to receive a call-back request that comprises a telephone number for a voice mail message associated with a training exercise, and permit an employee to perform one or more tasks associated with the training exercise; and
the one or more computer systems is configured to send the call-back request to mobile device, present the voice mail message to the employee in response to an incoming telephone call directed to the telephone number of the call-back request, and monitor the mobile computing device to determine whether the employee has successfully completed the training exercise in response to the presented voice mail message.

16. The training system of claim 15, wherein:
the mobile computing device is one of a plurality of mobile computing devices coupled to the one ore more backend systems via the one or more networks;
each mobile computing device of the plurality of computing devices is configured to permit an employee to sign into at least one backend system of the plurality of backend systems; and
the one or more backend systems is configured to identify a plurality of employees who are currently signed-in, and select the employee to which the call-back request is sent from the plurality of employees who are currently signed-in.

17. The training system of claim 15, wherein:
the mobile computing device is one of a plurality of mobile computing devices coupled to the one ore more backend systems via the one or more networks;
each mobile computing device of the plurality of computing devices is configured to permit an employee to sign into at least one backend system of the plurality of backend systems; and
the one or more backend systems is configured to identify a plurality of employees who are currently signed-in, identify a location for each employee of the plurality of employees, and select the employee to which the call-back request is sent from the plurality of employees who are currently signed-in such that greater than a threshold number of employees from the same location are not undergoing training at the same time.

18. The training system of claim 15, wherein the one or more backend systems are further configured to store a plurality of voice mail messages for a plurality of distinct training exercises, wherein each voice mail message of the plurality of voice mail messages is associated with a distinct telephone phone, and select the training exercise and associated telephone number for the call-back request based on which of the plurality of training exercises the selected employee has successfully completed.

19. The training system of claim 15, wherein the one or more backend systems are further configured to simulate a customer's request for service via the presented voice mail message to the employee, and monitor activities associated with the simulated customer's request for service to determine whether the employee has successfully completed the training exercise in response to the simulated customer's request for service.

20. The training system of claim 15, wherein:
the presented voice mail message instructs the employee to perform a task via the mobile computing device associated with the employee; and
the one or more backend systems are further configured to monitor signals received from the mobile computing device to determine, based upon the received signals, whether the task has been performed as requested.
